(19) United States
(12) Patent Application Publication
(10) Pub. No.: US 2024/0111724 A1
(43) Pub. Date: Apr. 4, 2024

(54) REPURPOSING PREVIOUS SLICING ARTIFACTS FOR A NEW SLICING FOR CONTROLLABLE AND DYNAMIC SLICE SIZE AND REDUCING THE IN-MEMORY FOOTPRINT FOR LARGER SHARES HAVING BILLIONS OF FILES

(71) Applicant: Dell Products L.P., Round Rock, TX (US)

(72) Inventors: Sunil K. Yadav, Bangalore (IN); Soumen Acharya, Bangalore (IN)

(21) Appl. No.: 17/936,935

(22) Filed: Sep. 30, 2022

(51) Int. Cl. G06F 16/16; G06F 16/14; G06F 16/182

(52) U.S. Cl. CPC G06F 16/164; G06F 16/148; G06F 16/182

(57) ABSTRACT

One example method includes, in response to completion of a portion of a crawling process performed in a filesystem, instantiating a slice creation process, receiving slicing criteria concerning the slice creation process, slicing filesystem data to create slices according to the slicing criteria, and servicing a query by returning a list that lists one or more of the slices. The slicing criteria may include a specified number of slices and/or a specified size for the slices.

### RELATED APPLICATIONS

This application is related to: (1) U.S. patent application Ser. No. 17/660,773, entitled BALANCING OF SLICES WITH CONSOLIDATION AND RE-SLICING, and filed Apr. 26, 2022; and (2) U.S. patent application, Ser. No. XX/YYYYYY (attorney docket 16192.667), entitled DYNAMIC SLICING USING A BALANCED APPROACH BASED ON SYSTEM RESOURCES FOR MAXIMUM OUTPUT, and filed the same day herewith. All of the aforementioned applications are incorporated herein in their respective entireties by this reference.

### FIELD OF THE INVENTION

Embodiments of the present invention generally relate to data protection. More particularly, at least some embodiments of the invention relate to systems, hardware, software, computer-readable media, and methods, for data tagging and slice creation after a filesystem crawl has been performed.

### BACKGROUND

A data slicing mechanism as disclosed in the Related Application, may involve the use of an in-memory data structure for tagging of a folder and keeping track of the tagged folder. In some cases however, the slices of the data in the folder may be made using a fixed size threshold value. In some circumstances, the use of an in-memory data structure for large slices may lead to memory overrun issue and system underperformance. Further, the outcome of a slicing process may be static in the sense that the slicing process may be controlled by the use of slices of a fixed size. If a new slice size is to be used, it may be necessary to re-slice all of the data to bring the slices into conformance with the new size. This approach may result in the inefficient use of time and computing resources.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example operating environment for some embodiments.

FIG. 2 discloses aspects of an example method according to some embodiments.

FIG. 3 discloses aspects of an example computing entity operable to perform any of the disclosed methods, processes, and operations.

### DETAILED DESCRIPTION OF SOME EXAMPLE EMBODIMENTS

Embodiments of the present invention generally relate to data protection. More particularly, at least some embodiments of the invention relate to systems, hardware, software, computer-readable media, and methods, for data tagging and slice creation after a filesystem crawl has been performed.

In general, some embodiments of the invention are directed to methods for efficiently handling data tagging and slice creation. These operations may be performed after the completion of a filesystem crawling process. In more detail, some embodiments may operate to repurpose existing slicing artifacts according to a new slicing scheme, so as to implement controllable and dynamic slice sizing. Such embodiments may reduce the in-memory footprint for filesystem shares, which may have billions of files.

One embodiment may comprise a method that is performed after, and possibly triggered by, a filesystem crawl process. The crawled items for each file and folder may be maintained in a database (DB), such as a SQL database for example. In the database, a DB schema may be employed that may store, among other things, information such as path, parent path, size, and type (file/folder). Each file size entry may be updated after the crawling process has been completed. A composite query may be run to update folder sizes recursively. Each folder may be tagged with its size, after which a user may request, such as by way of a SQL query for example, the retrieval of one or more slices based on slice size input parameters, such as 100 GB slice size or 200 GB slice size, for example. Particularly, a use query may identify slices matching with the input threshold and, in response to the query, slices matching, such as in terms of their size for example, the parameters specified in the query may be returned by the system. In some embodiments, a pre-configured slice of a fixed size may be defined, such as by a user, and created for circumstances where the user wants to restrict the total number of slices to a certain value. Then, based on the slice number limit, an embodiment may identify the threshold size for equal distribution of data, and the slices may then be created.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may provide flexibility in determining the size and number of slices that are to be created. As another example, an embodiment may size and create slices based on available computing resources. An embodiment may cut a filesystem into slices that may enable the use of parallel backup streams. An embodiment may implement functions such as these in a ‘big data’ filesystem that may comprise large amounts of data, that may be non-homogenous, distributed across many folders and directories. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of an Example Architecture and Environment

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, 10 replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

New and/or modified data collected and/or generated in connection with some embodiments, may be stored in one or more filesystems (FS) that may be located on-premises, such as at an enterprise, and/or at a remote site such as a cloud storage site. This data may be backed up in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)s.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

### B. Overview

A filesystem data layout can be distributed in different folders in a non-homogenous way. Backing up such file shares using a parallel backup mechanism is a challenge. To achieve an effective parallel backup mechanism for a file share, there is a need to create logical chunks, or slices, of a filesystem in non-overlapping manner such that each slice can be backed up independently via separate respective backup channel. This approach may provide better backup performance for a large file share.

The slices may be created within a threshold limit so that all slices are the same size, or nearly so, such as within about 5-10 percent of each other. The use of uniformly sized slices may enable an optimum, or at least improved, utilization of backup streams. Some example slicing processes are disclosed in the Related Applications. In some circumstances, such slicing processes may have certain limitations with respect to the way filesystem is crawled, and with respect to the in-memory data tagging and slice creation. Thus, some embodiments of the invention may provide efficient ways to handle data tagging, and slice creation, after a filesystem crawling process has been completed.

### C. Aspects of an Example System Configuration

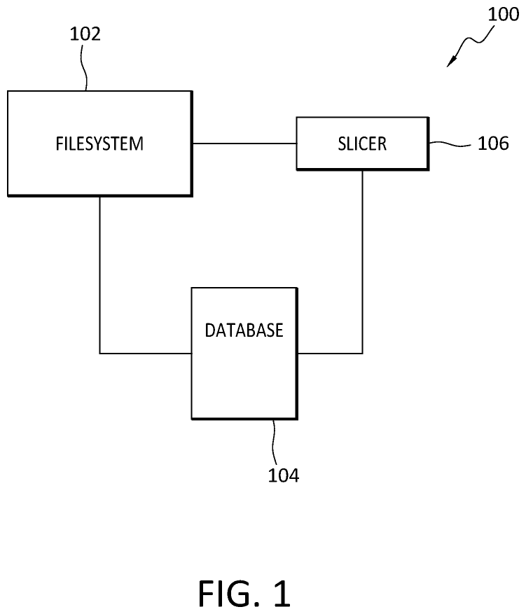

Directing attention now to FIG. 1, some details are provided concerning an example architecture and environment 100 for some embodiments of the invention. The configuration disclosed in FIG. 1 is presented in a simplified form for clarity and the purposes of illustration.

As shown, a filesystem (FS) 102 may be provided that includes and enables access to, for example, various directories, sub-directories, folders, and files. The files, directories, folders, and sub-directories may be distributed across a variety of locations, which may be geographically separated from one another. The FS 102 may be any size, and in some instances, may comprise billions of files.

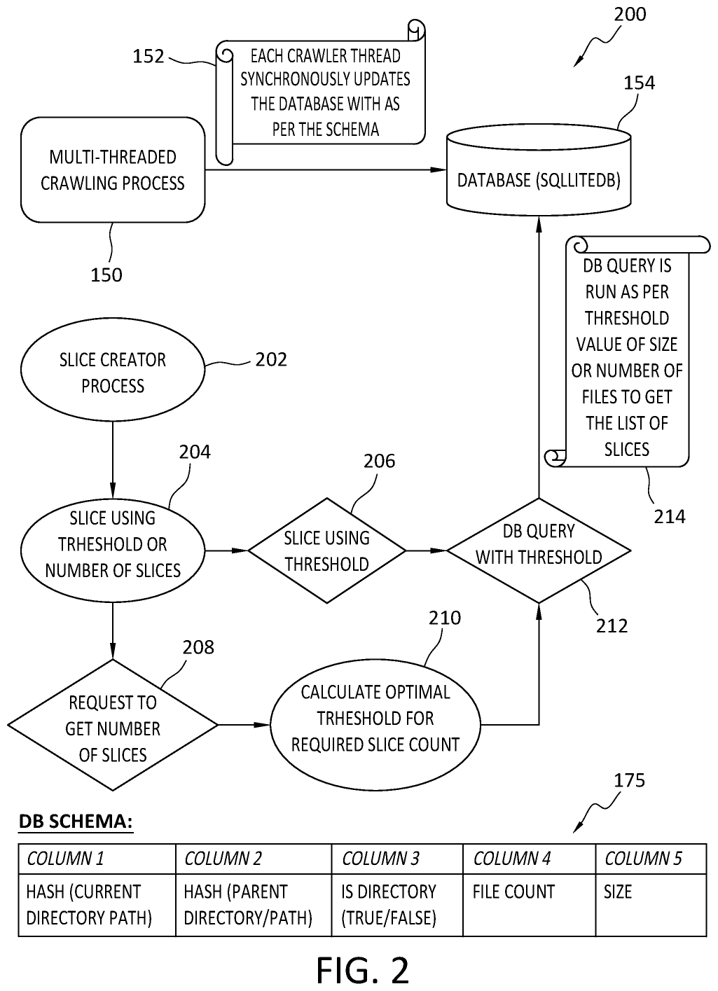

The FS 102 data, including the files, may be stored in a database (DB) 104 that may or may not be a part of the FS 102. In some embodiments, the database 104 may be a SQL database, but no particular type of database 104 is required for any embodiment. As disclosed in further detail in the discussion of FIG. 2, the database 104 may include a DB schema, or simply ‘schema,’ that may store information such as, but not limited to, path, parent path, and size/type of files and folders. In some embodiments, the DB 104 may also include information such as the number of slices, and the size of the slices.

As further indicated in FIG. 1, a slicer 106 may be provided that, in general, may operate to slice FS 102 data into slices of various sizes. In some instances, commencement of the operation of the slicer 106 may be triggered, possibly automatically, by the completion of an FS crawling process, examples of which are disclosed in one or more of the Related Applications. In some embodiments, the slicer 106 may receive input, directly or indirectly, from a user indicating the size of slices to be created. This input may change from time to time, such that the slicer 106 may have to slice, and/or re-slice, data based on this dynamic input. In some instances, the slicer 106 may re-slice existing slices into yet other slices of a specified size and/or number. Further example operations of an embodiment of a slicer are disclosed elsewhere herein.

### D. Aspects of Example Methods

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 2, aspects of an example method 200 are disclosed. One or more of the operations of the method 200, such as a slice creator process, may be performed by a slicer, such as the slicer 106 for example, possibly in response to user input and/or in response to a notification that a FS crawling process has been completed. The instantiation and performance of the method 200 may occur automatically in response to such user input and/or notification.

As a prerequisite, in one embodiment, to performance of the method 200, a multi-threaded crawling process 150, or simply ‘crawling process,’ examples of which are disclosed in one or more of the Related Application, may be performed. As part of the crawling process 150, each crawler thread, or crawl job, may synchronously update 152 a DB 154, such as a SQL DB for example, with information specified by a DB schema 175.

In the example of FIG. 2, the schema 175 may comprise various fields for each record of a FS node, such as a directory or folder for example, that has been crawled. In the interest of conserving memory in a database where the schema 175 may be stored, the various fields of a folder record or directory record may hold hash values. In the illustrated example, ‘Column 1’ holds a hash of a current directory path, ‘Column 2’ holds a hash of parent directory path, ‘Column 3’ contains a binary True/False indication as to whether the FS node is a directory or not, ‘Column 4’ holds a file count for the FS node, and ‘Column 5’ holds a folder size value for the amount of data contained in the FS node. Additional, or alternative, information may be included in the schema 175.

The method 200 may begin with instantiation of a slice creator process 202. Next, the data, in a file share for example, may be sliced 204 by the slicer. The slicing 204 may be performed according to various criteria, which may be user specified and/or may comprise system defaults. The criteria may change from time to time, and the updated criteria provided to the slicer. Thus, in some instances, the slicing 204 may comprise a re-slicing of existing slices based on new or modified slicing criteria input. In any case, example slicing criteria include, but are not limited to, a specified number slices, and a specified slice size. Criteria such as these may be used alone, or in combination, to determine the outcome of a slicing 204 process.

Where the slicing criteria comprises a specified threshold slice size, the slicing 204 operation may comprise slicing the data 206 into slices of the specified size. As another example, when the slicing criteria comprises a particular number of slices, the method 200 may obtain 208 the number of slices required. When the number of slices are known, the method 200 may calculate 210 an optimal slice size to be created. For example, if the specified number of slices is 10, and the total amount of data to be sliced is 500 GB, the threshold size for each slice, given a required slice count of 10, would be 50 GM (500 GB/10).

At some point after the slicing operation(s) have been performed, a query 212 may be defined and transmitted to the DB 154. In one embodiment, the query may specify, for example, a particular number of slices and/or a particular size for each of the slices. The response to the query 212 may comprise a list of slices 214 that meet the criteria specified in the query. Because the schema 175 in the DB 154 may be updated recursively, the query 212 may return slices of the most up-to-date sizes, and numbers.

### E. Further Example Embodiments

Following are some further example embodiments of the invention. These are presented only by way of example and are not intended to limit the scope of the invention in any way.

Embodiment 1. A method, comprising: in response to completion of a portion of a crawling process performed in a filesystem, instantiating a slice creation process; receiving slicing criteria concerning the slice creation process; slicing filesystem data to create slices according to the slicing criteria; and servicing a query by returning a list that lists one or more of the slices.

Embodiment 2. The method as recited in embodiment 1, wherein the query is received after a filesystem folder or directory implicated by the query has been tagged with its size.

Embodiment 3. The method as recited in any of embodiments 1-2, wherein the query specifies a slice size.

Embodiment 4. The method as recited in any of embodiments 1-3, wherein the query specifies a number of slices.

Embodiment 5. The method as recited in any of embodiments 1-4, wherein the filesystem spans multiple, geographically dispersed data storage entities.

Embodiment 6. The method as recited in any of embodiments 1-5, wherein the query is received at a database that holds a schema with information about one or more folders and/or directories in the filesystem that was crawled by the crawling process.

Embodiment 7. The method as recited in any of embodiments 1-6, wherein the slicing comprises re-slicing one or more existing slices.

Embodiment 8. The method as recited in any of embodiments 1-7, wherein the returned slices meet criteria specified in the query.

Embodiment 9. The method as recited in any of embodiments 1-8, wherein the query is received at a database that holds a schema that is accessible by one or more threads of the crawling process.

Embodiment 10. The method as recited in any of embodiments 1-9, wherein the slicing criteria specifies a number of slices, and a size for each slice is calculated based on the specified number of slices.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

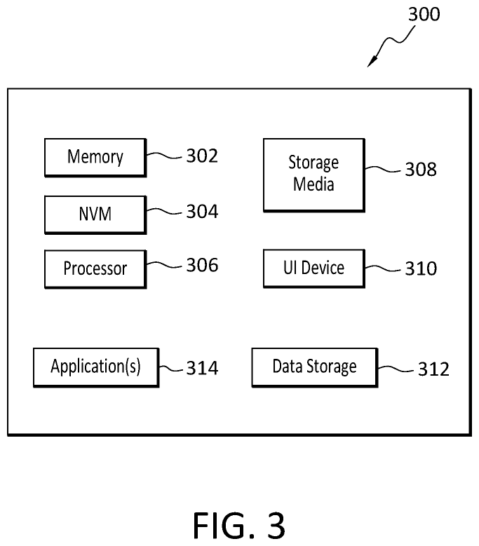

With reference briefly now to FIG. 3, any one or more of the entities disclosed, or implied, by FIGS. 1-2 and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI (user interface) device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
in response to completion of a portion of a crawling process performed in a filesystem, instantiating a slice creation process;
receiving slicing criteria concerning the slice creation process;
slicing filesystem data to create slices according to the slicing criteria; and
servicing a query by returning a list that lists one or more of the slices.

2. The method as recited in claim 1, wherein the query is received after a filesystem folder or directory implicated by the query has been tagged with its size.

3. The method as recited in claim 1, wherein the query specifies a slice size.

4. The method as recited in claim 1, wherein the query specifies a number of slices.

5. The method as recited in claim 1, wherein the filesystem spans multiple, geographically dispersed data storage entities.

6. The method as recited in claim 1, wherein the query is received at a database that holds a schema with information about one or more folders and/or directories in the filesystem that was crawled by the crawling process.

7. The method as recited in claim 1, wherein the slicing comprises re-slicing one or more existing slices.

8. The method as recited in claim 1, wherein the returned slices meet criteria specified in the query.

9. The method as recited in claim 1, wherein the query is received at a database that holds a schema that is accessible by one or more threads of the crawling process.

10. The method as recited in claim 1, wherein the slicing criteria specifies a number of slices, and a size for each slice is calculated based on the specified number of slices.

11. A non-transitory storage medium having stored therein instructions that are executable by one or more hardware processors to perform operations comprising:
in response to completion of a portion of a crawling process performed in a filesystem, instantiating a slice creation process;
receiving slicing criteria concerning the slice creation process;
slicing filesystem data to create slices according to the slicing criteria; and
servicing a query by returning a list that lists one or more of the slices.

12. The non-transitory storage medium as recited in claim 11, wherein the query is received after a filesystem folder or directory implicated by the query has been tagged with its size.

13. The non-transitory storage medium as recited in claim 11, wherein the query specifies a slice size.

14. The non-transitory storage medium as recited in claim 11, wherein the query specifies a number of slices.

15. The non-transitory storage medium as recited in claim 11, wherein the filesystem spans multiple, geographically dispersed data storage entities.

16. The non-transitory storage medium as recited in claim 11, wherein the query is received at a database that holds a schema with information about one or more folders and/or directories in the filesystem that was crawled by the crawling process.

17. The non-transitory storage medium as recited in claim 11, wherein the slicing comprises re-slicing one or more existing slices.

18. The non-transitory storage medium as recited in claim 11, wherein the returned slices meet criteria specified in the query.

19. The non-transitory storage medium as recited in claim 11, wherein the query is received at a database that holds a schema that is accessible by one or more threads of the crawling process.

20. The non-transitory storage medium as recited in claim 11, wherein the slicing criteria specifies a number of slices, and a size for each slice is calculated based on the specified number of slices.
